(19) United States
(12) Patent Application Publication
(10) Pub. No.: US 2004/0125138 A1
(43) Pub. Date: Jul. 1, 2004

(54) Detail-in-context lenses for multi-layer images

(76) Inventors: Zeenat Jetha, North Vancouver (CA); Garth Shoemaker, Vancouver (CA); Stacy Gorkoff, Vancouver (CA)

Correspondence Address: Ogilvy Renault, Suite 1600, 1981 McGill College Avenue, Montreal, QC, H3A 2Y3, CA

(21) Appl. No.: 10/682,298

(22) Filed: Oct. 10, 2003

(30) Foreign Application Priority Data
Oct. 10, 2002 (CA) 2,407,383

(51) Int. Cl. G09G 5/00

(52) U.S. Cl. 345/764

(57) ABSTRACT

A method for editing a multi-layer original image presented on a display, comprising: in response to receiving an indication to edit a region of the original image, distorting a predetermined portion of a first layer of the original image to produce a distorted image for the region; overlaying the distorted image on a second layer of the original image to produce an overlaid image for presentation on the display; and, upon completion of editing of the overlaid image, selectively propagating edits made to the first layer through to remaining layers of said original image. And, a method for presenting a region of a multi-layer original image on a system display, comprising: distorting a predetermined portion of a first layer of the original image to produce a distorted image for the region; and, overlaying the distorted image on a second layer of the original image for presentation on the system display.

### This application claims priority from Canadian Patent Application No. 2,407,383, filed Oct. 10, 2002, the disclosure of which is incorporated herein by reference.

### FIELD OF THE INVENTION

This invention relates to the field of computer graphics processing, and more specifically, to a method and system for presenting and editing images having multiple layers using detail-in-context lenses and a detail-in-context graphical user interface (“GUI”).

### BACKGROUND OF THE INVENTION

One disadvantage of existing methods and graphical user interfaces for editing multi-layer digital images is that they do not provide a user-friendly indication to users of the effect that an editing operation performed on one layer has on other layers. A related problem is that of accurately selecting an area or object to be edited when that area or object appears in multiple layers of an image. Accordingly, a user may have to repeat the editing operation several times in order to achieve the desired result. In other words, while present editing methods may provide a user with a desired multi-layer image after several iterations, these methods do not provide for the accurate selection of the desired area or object to be edited at the outset. Thus, and especially for large image presentations such as digital maps, a user may have to repeat the editing operation several times in order to accurately select the desired area or object. For example, while a user may use well-known “panning” and “zooming” tools to view a desired area or object in a first layer of the original image for editing, in doing so, the relative location of the corresponding area or object in a second layer of the original image may be lost to the user or the user may find it difficult to determine what portion of the original image is being observed. Thus, while the user may have gained a detailed view of a region of an original image layer that is of interest, the user may lose sight of the context within which that region is positioned with respect other layers of the image. This is an example of what is often referred to as the “screen real estate problem”.

Several systems and methods have been proposed for viewing and manipulating multilayer images. For example, U.S. Pat. No. 6,522,341 to Nagata discloses a multi-layer image mixing apparatus for creating a composite image from multiple image layers. The apparatus is so constructed as to independently set the presentation order and opacities for respective layers, and is suitably applicable to presenting maps and cursors on a car navigation system, for example. However, the Nagata apparatus does not allow for accurate contextual editing of multiple image layers. As another example, U.S. Pat. No. 6,067,372 to Gur, et al., discloses a method and system for detecting abnormal regions in layered mammograms. When a new image layer is processed, the image is subject to repeated analyses after minor modification of the digital values' distribution. Every suspicious region is computed several times after digital values are modified (e.g., noise is added or the image is re-digitized). The results are then used as an input to a statistical computation as to whether or not the region is abnormal. However, like Nagata, Gur, et al., does not allow for the effective modification of digital values (i.e., editing) for one image layer within the context of a second image layer.

A need therefore exists for an improved method and system for presenting and editing layered digital images. Consequently, it is an object of the present invention to obviate or mitigate at least some of the above mentioned disadvantages.

### SUMMARY OF THE INVENTION

According to one aspect of the invention, there is provided a method for editing a multilayer original image presented on a system display, comprising: in response to receiving an indication to edit a region of the original image, distorting a predetermined portion of a first layer of the original image to produce a distorted image for the region; overlaying the distorted image on a second layer of the original image to produce an overlaid image for presentation on the system display; and, upon completion of editing of the overlaid image, selectively propagating edits made to the first layer through to remaining layers of the original image.

Preferably, the step of distorting further includes: creating a lens surface for the distorted image; and, transforming the predetermined portion of the first layer by applying a distortion function defining the lens surface to the predetermined portion of the first layer.

Preferably, the step of creating further includes displaying a graphical user interface (“GUI”) over the distorted image for adjusting the lens surface.

Preferably, the lens surface includes a focal region and a base region and the GUI includes: a slide bar icon for adjusting a magnification for the lens surface; a slide bar icon for adjusting a degree of scooping for the lens surface; a bounding rectangle icon with at least one handle icon for adjusting a size and a shape for the focal region; a bounding rectangle icon with at least one handle icon for adjusting a size and a shape for the base region; a move icon for adjusting a location for the lens surface within the first layer; a pickup icon for adjusting a location for the base region within the first layer; and, a fold icon for adjusting a location for the focal region relative to the base region.

Preferably, the GUI further includes a layer toggle icon or a layer toggle keyboard input for switching among the first and second layers.

Preferably, the GUI further includes a layer selection icon or a layer selection keyboard input for selecting among the first and second layers.

Preferably, the GUI further includes a layer fold icon or a layer fold keyboard input for selecting a folded lens surface.

Preferably, the folded lens surface includes a second focal region for displaying a portion of the second layer.

Preferably, the focal region is folded away from an original position relative to the base region.

Preferably, the second focal region is located at the original position.

Preferably, the GUI further includes a layer clear icon or a layer clear keyboard input for selecting a user adjustable window for display in the focal region.

Preferably, the window displays a portion of the second layer.

Preferably, adjusting the GUI is performed and the indication is generated by moving a cursor on the system display with a pointing device.

Preferably, the first and second layers are raster, vector, point, or geo-referenced data layers.

Preferably, the indication, region, predetermined portion, first layer, distorted image, and second layer includes a number of indications, regions, predetermined portions, first layers, distorted images, and second layers, respectively.

Preferably, the layer toggle icon, layer toggle keyboard input, layer selection icon, layer selection keyboard input, layer fold icon, layer fold keyboard input, layer clear icon, and layer clear keyboard input includes a number of layer toggle icons, layer toggle keyboard inputs, layer selection icons, layer selection keyboard inputs, layer fold icons, layer fold keyboard inputs, layer clear icons, and layer clear keyboard inputs, respectively.

Preferably, the method further includes the step of saving the edits for subsequent recall and application.

Preferably, the edits are saved as bookmarks.

Preferably, the editing includes applying the bookmarks.

According to another aspect of the invention, there is provided a method for presenting a region of a multi-layer original image on a system display, comprising: distorting a predetermined portion of a first layer of the original image to produce a distorted image for the region; and, overlaying the distorted image on a second layer of the original image for presentation on the system display.

Preferably, the step of distorting further includes: creating a lens surface for the distorted image; and, transforming the predetermined portion of the first layer by applying a distortion function defining the lens surface to the predetermined portion of the first layer.

Preferably, the step of creating further includes displaying a graphical user interface (“GUI”) over the distorted image for adjusting the lens surface.

Preferably, the lens surface includes a focal region and a base region and the GUI includes: a slide bar icon for adjusting a magnification for the lens surface; a slide bar icon for adjusting a degree of scooping for the lens surface; a bounding rectangle icon with at least one handle icon for adjusting a size and a shape for the focal region; a bounding rectangle icon with at least one handle icon for adjusting a size and a shape for the base region; a move icon for adjusting a location for the lens surface within the first layer; a pickup icon for adjusting a location for the base region within the first layer; and, a fold icon for adjusting a location for the focal region relative to the base region.

Preferably, the GUI further includes a layer toggle icon or a layer toggle keyboard input for switching among the first and second layers.

Preferably, the GUI further includes a layer selection icon or a layer selection keyboard input for selecting among the first and second layers.

Preferably, the GUI further includes a layer fold icon or a layer fold keyboard input for selecting a folded lens surface.

Preferably, the folded lens surface includes a second focal region for displaying a portion of the second layer.

Preferably, the focal region is folded away from an original position relative to the base region.

Preferably, the second focal region is located at the original position.

Preferably, the GUI further includes a layer clear icon or a layer clear keyboard input for selecting a user adjustable window for display in the focal region.

Preferably, the window displays a portion of the second layer.

Preferably, adjusting the GUI is performed by moving a cursor on the system display with a pointing device.

Preferably, the first and second layers are raster, vector, point, or geo-referenced data layers.

Preferably, the indication, region, predetermined portion, first layer, distorted image, and second layer includes a number of indications, regions, predetermined portions, first layers, distorted images, and second layers, respectively.

Preferably, the layer toggle icon, layer toggle keyboard input, layer selection icon, layer selection keyboard input, layer fold icon, layer fold keyboard input, layer clear icon, and layer clear keyboard input includes a number of layer toggle icons, layer toggle keyboard inputs, layer selection icons, layer selection keyboard inputs, layer fold icons, layer fold keyboard inputs, layer clear icons, and layer clear keyboard inputs, respectively.

Advantageously, since the magnification at the focus of the lens surface is typically greater than that at the base of the lens, a user is assisted throughout an editing operation by being able to observe the detail in the lens focus in the context of the surrounding layered presentation.

### BRIEF DESCRIPTION OF THE DRAWINGS

Embodiments of the invention may best be understood by referring to the following description and accompanying drawings. In the description and drawings, like numerals refer to like structures or processes. In the drawings:

FIG. 1 is a graphical representation of the geometry for constructing a three-dimensional (3D) perspective viewing frustum, relative to an x, y, z coordinate system, in accordance with known elastic presentation space graphics technology;

FIG. 2 is a graphical representation of the geometry of a presentation in accordance with known elastic presentation space graphics technology;

FIG. 3 is a block diagram illustrating a data processing system adapted for implementing an embodiment of the invention;

FIG. 4 a partial screen capture illustrating a GUI having lens control elements for user interaction with detail-in-context data presentations in accordance with an embodiment of the invention;

FIG. 5 is a screen capture illustrating a presentation having a detail-in-context lens and an associated GUI for editing an original single-layer digital image or representation in accordance with an embodiment of the invention;

FIG. 6 is a screen capture illustrating a presentation having a detail-in-context lens and an associated GUI for editing an original multi-layer digital image or representation in accordance with an embodiment of the invention;

FIG. 7 is a screen capture illustrating the placement of a mark over a selected area or object in the lens image for a layer of an original multi-layer digital image or representation in accordance with an embodiment of the invention;

FIG. 8 is a screen capture illustrating the penetration of a mark placed over a selected area or object in a first layer of an original multi-layer digital image or representation through to a second layer of that original image in accordance with an embodiment of the invention;

FIG. 9 is a screen capture illustrating the effect of a layer toggle control element on a detail-in-context presentation for a multi-layer original image in accordance with an embodiment of the invention;

FIG. 10 is a graphical representation illustrating the folding of the focal region of a lens to produce a folded lens having a folded focal region in accordance with an embodiment of the invention;

FIG. 11 is a screen capture illustrating the effect of a layer fold control element on a detail-in-context presentation for a multi-layer original image in accordance with an embodiment of the invention;

FIG. 12 is a screen capture illustrating the effect of a layer clear control element on a detail-in-context presentation for a multi-layer original image in accordance with an embodiment of the invention;

FIG. 13 is a screen capture illustrating a non-rectangular layer clear window in which the occluded layer presented is further magnified, in accordance with an embodiment of the invention; and,

FIG. 14 is a flow chart illustrating a method for editing a multi-layer original image presented on a system display in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known software, circuits, structures and techniques have not been described or shown in detail in order not to obscure the invention. The term “data processing system” is used herein to refer to any machine for processing data, including the computer systems and network arrangements described herein.

The “screen real estate problem” mentioned above generally arises whenever large amounts of information are to be displayed on a display screen of limited size. Known tools to address this problem include panning and zooming. While these tools are suitable for a large number of visual display applications, they become less effective where sections of the visual information are spatially related, such as in layered maps and three-dimensional representations, for example. In this type of information display, panning and zooming are not as effective as much of the context of the panned or zoomed display may be hidden.

A recent solution to this problem is the application of “detail-in-context” presentation techniques. Detail-in-context is the magnification of a particular region-of-interest (the “focal region” or “detail”) in a data presentation while preserving visibility of the surrounding information (the “context”). This technique has applicability to the display of large surface area media (e.g. digital maps) on computer screens of variable size including graphics workstations, laptop computers, personal digital assistants (“PDAs”), and cell phones.

In the detail-in-context discourse, differentiation is often made between the terms “representation” and “presentation”. A representation is a formal system, or mapping, for specifying raw information or data that is stored in a computer or data processing system. For example, a digital map of a city is a representation of raw data including street names and the relative geographic location of streets and utilities. Such a representation may be displayed visually on a computer screen or printed on paper. On the other hand, a presentation is a spatial organization of a given representation that is appropriate for the task at hand. Thus, a presentation of a representation organizes such things as the point of view and the relative emphasis of different parts or regions of the representation. For example, a digital map of a city may be presented with a region magnified to reveal street names.

In general, a detail-in-context presentation may be considered as a distorted view (or distortion) of a portion of the original representation or image where the distortion is the result of the application of a “lens” like distortion function to the original representation. A detailed review of various detail-in-context presentation techniques such as “Elastic Presentation Space” (“EPS”) (or “Pliable Display Technology” (“PDT”)) may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference.

In general, detail-in-context data presentations are characterized by magnification of areas of an image where detail is desired, in combination with compression of a restricted range of areas of the remaining information (i.e. the context), the result typically giving the appearance of a lens having been applied to the display surface. Using the techniques described by Carpendale, points in a representation are displaced in three dimensions and a perspective projection is used to display the points on a two-dimensional presentation display. Thus, when a lens is applied to a two-dimensional continuous surface representation, for example, the resulting presentation appears to be three-dimensional. In other words, the lens transformation appears to have stretched the continuous surface in a third dimension. In EPS graphics technology, a two-dimensional visual representation is placed onto a surface; this surface is placed in three-dimensional space; the surface, containing the representation, is viewed through perspective projection; and the surface is manipulated to effect the reorganization of image details. The presentation transformation is separated into two steps: surface manipulation or distortion and perspective projection.

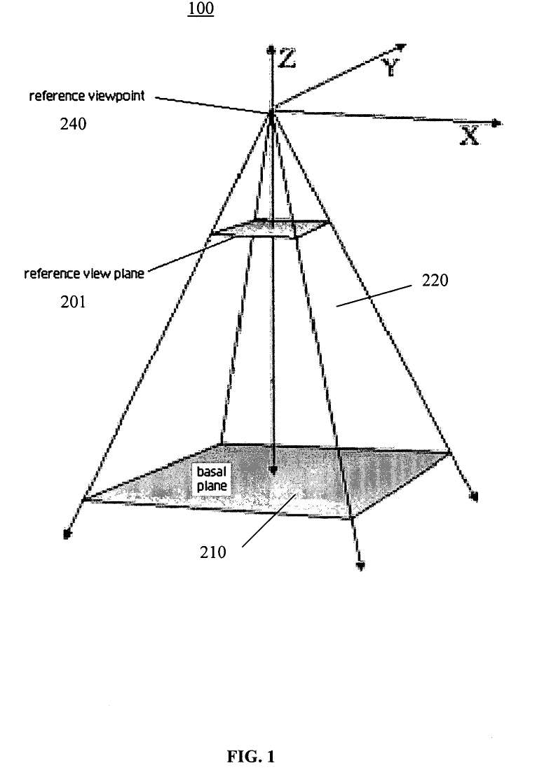

FIG. 1 is a graphical representation 100 of the geometry for constructing a three-dimensional (“3D”) perspective viewing frustum 220, relative to an x, y, z coordinate system, in accordance with known elastic presentation space (EPS) graphics technology. In EPS technology, detail-in-context views of two-dimensional (“2D”) visual representations are created with sight-line aligned distortions of a 2D information presentation surface within a 3D perspective viewing frustum 220. In EPS, magnification of regions of interest and the accompanying compression of the contextual region to accommodate this change in scale are produced by the movement of regions of the surface towards the viewpoint (“VP”) 240 located at the apex of the pyramidal shape 220 containing the frustum. The process of projecting these transformed layouts via a perspective projection results in a new 2D layout which includes the zoomed and compressed regions. The use of the third dimension and perspective distortion to provide magnification in EPS provides a meaningful metaphor for the process of distorting the information presentation surface. The 3D manipulation of the information presentation surface in such a system is an intermediate step in the process of creating a new 2D layout of the information.

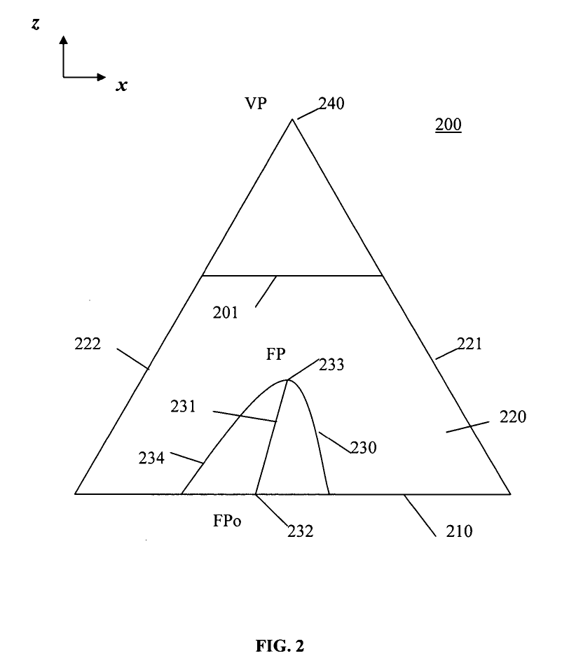

FIG. 2 is a graphical representation 200 of the geometry of a presentation in accordance with known EPS graphics technology. EPS graphics technology employs viewer-aligned perspective projections to produce detail-in-context presentations in a reference view plane 201 which may be viewed on a display. Undistorted 2D data points are located in a basal plane 210 of a 3D perspective viewing volume or frustum 220 which is defined by extreme rays 221 and 222 and the basal plane 210. The VP 240 is generally located above the centre point of the basal plane 210 and reference view plane (“RVP”) 201. Points in the basal plane 210 are displaced upward onto a distorted surface 230 which is defined by a general 3D distortion function (i.e. a detail-in-context distortion basis function). The direction of the viewer-aligned perspective projection corresponding to the distorted surface 230 is indicated by the line FPo—FP 231 drawn from a point FPo 232 in the basal plane 210 through the point FP 233 which corresponds to the focus or focal region or focal point of the distorted surface 230.

EPS is applicable to multidimensional data and is well suited to implementation on a computer for dynamic detail-in-context display on an electronic display surface such as a monitor. In the case of two dimensional data, EPS is typically characterized by magnification of areas of an image where detail is desired 233, in combination with compression of a restricted range of areas of the remaining information (i.e. the context) 234, the end result typically giving the appearance of a lens 230 having been applied to the display surface. The areas of the lens 230 where compression occurs may be referred to as the “shoulder” 234 of the lens 230. The area of the representation transformed by the lens may be referred to as the “lensed area”. The lensed area thus includes the focal region and the shoulder. To reiterate, the source image or representation to be viewed is located in the basal plane 210. Magnification 233 and compression 234 are achieved through elevating elements of the source image relative to the basal plane 210, and then projecting the resultant distorted surface onto the reference view plane 201. EPS performs detail-in-context presentation of n-dimensional data through the use of a procedure wherein the data is mapped into a region in an (n+1) dimensional space, manipulated through perspective projections in the (n+1) dimensional space, and then finally transformed back into n-dimensional space for presentation. EPS has numerous advantages over conventional zoom, pan, and scroll technologies, including the capability of preserving the visibility of information outside 234 the local region of interest 233.

For example, and referring to FIGS. 1 and 2, in two dimensions, EPS can be implemented through the projection of an image onto a reference plane 201 in the following manner. The source image or representation is located on a basal plane 210, and those regions of interest 233 of the image for which magnification is desired are elevated so as to move them closer to a reference plane situated between the reference viewpoint 240 and the reference view plane 201. Magnification of the focal region 233 closest to the RVP 201 varies inversely with distance from the RVP 201. As shown in FIGS. 1 and 2, compression of regions 234 outside the focal region 233 is a function of both distance from the RVP 201, and the gradient of the function describing the vertical distance from the RVP 201 with respect to horizontal distance from the focal region 233. The resultant combination of magnification 233 and compression 234 of the image as seen from the reference viewpoint 240 results in a lens-like effect similar to that of a magnifying glass applied to the image. Hence, the various functions used to vary the magnification and compression of the source image via vertical displacement from the basal plane 210 are described as lenses, lens types, or lens functions. Lens functions that describe basic lens types with point and circular focal regions, as well as certain more complex lenses and advanced capabilities such as folding, have previously been described by Carpendale.

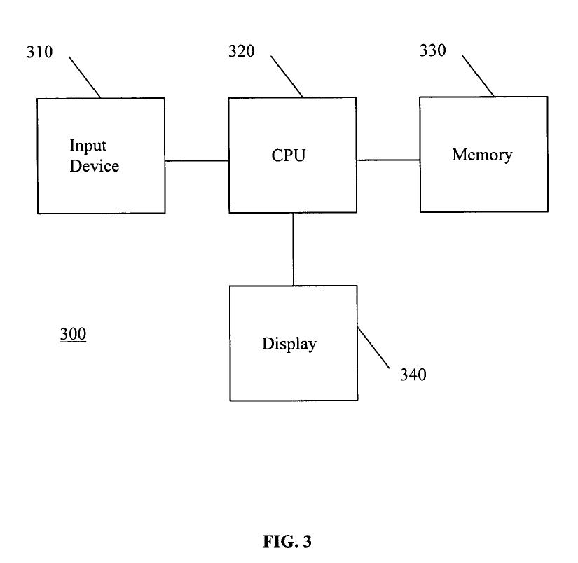

System. FIG. 3 is a block diagram of a data processing system 300 adapted to implement an embodiment of the invention. The data processing system is suitable for implementing EPS technology, for displaying detail-in-context presentations of representations, and for editing images having multiple layers in conjunction with a detail-in-context graphical user interface (“GUI”) 400, as described below. The data processing system 300 includes an input device 310, a central processing unit or CPU 320, memory 330, and a display 340. The input device 310 may include a keyboard, mouse, trackball, or similar device. The CPU 320 may include dedicated coprocessors and memory devices. The memory 330 may include RAM, ROM, databases, or disk devices. And, the display 340 may include a computer screen, terminal device, or a hardcopy producing output device such as a printer or plotter. The data processing system 300 has stored therein data representing sequences of instructions which when executed cause the method described herein to be performed. Of course, the data processing system 300 may contain additional software and hardware a description of which is not necessary for understanding the invention.

GUI with Lens Control Elements. As mentioned, detail-in-context presentations of data using techniques such as pliable surfaces, as described by Carpendale, are useful in presenting large amounts of information on limited-size display surfaces. Detail-in-context views allow magnification of a particular region-of-interest (the “focal region”) 233 in a data presentation while preserving visibility of the surrounding information 210. In the following, a GUI 400 is described having lens control elements that can be implemented in software and applied to the editing of multi-layer images and to the control of detail-in-context data presentations. The software can be loaded into and run by the data processing system 300 of FIG. 3.

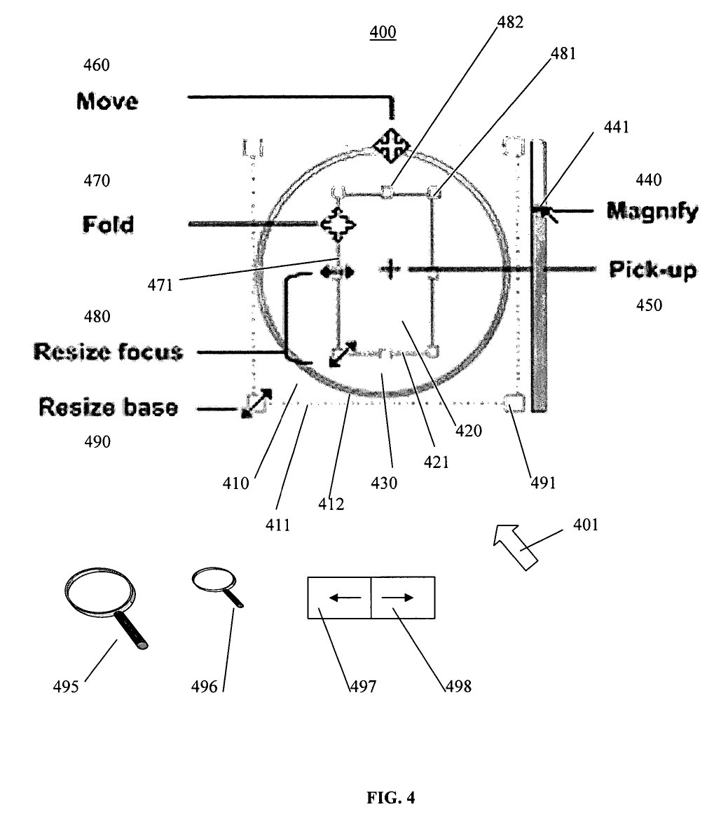

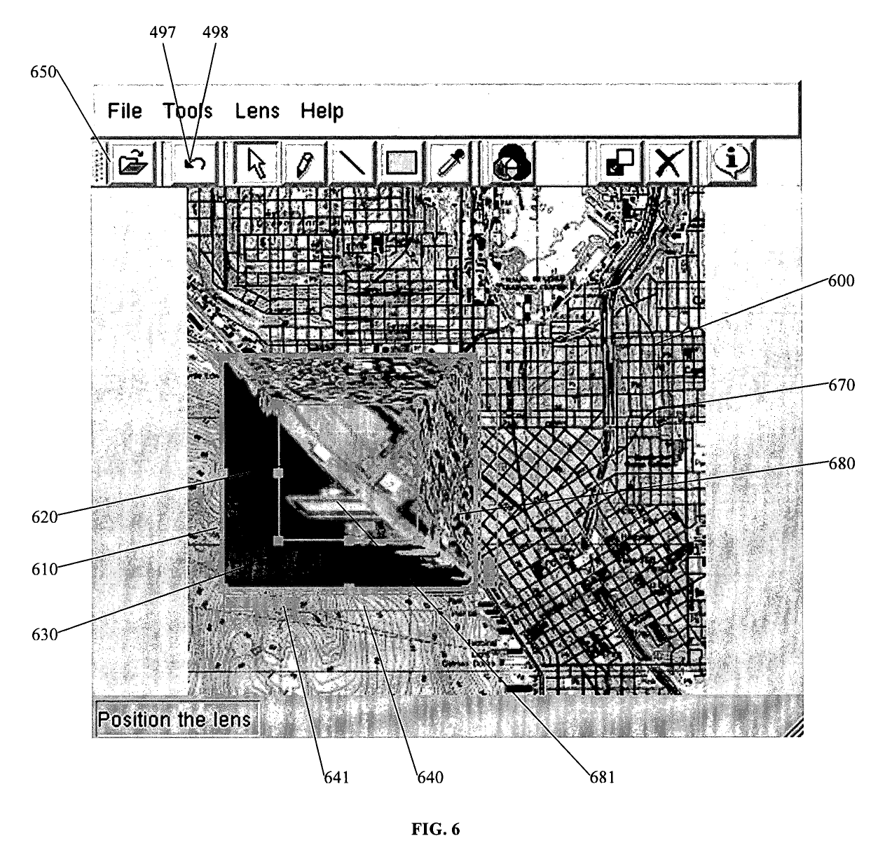

FIG. 4 is a partial screen capture illustrating a GUI 400 having lens control elements for user interaction with detail-in-context data presentations in accordance with an embodiment of the invention. Detail-in-context data presentations are characterized by magnification of areas of an image where detail is desired, in combination with compression of a restricted range of areas of the remaining information (i.e. the context), the end result typically giving the appearance of a lens having been applied to the display screen surface. This lens 410 includes a “focal region” 420 having high magnification, a surrounding “shoulder region” 430 where information is typically visibly compressed, and a “base” 412 surrounding the shoulder region 430 and defining the extent of the lens 410. In FIG. 4, the lens 410 is shown with a circular shaped base 412 (or outline) and with a focal region 420 lying near the center of the lens 410. However, the lens 410 and focal region 420 may have any desired shape. For example, in FIG. 6, the lens 610 has a pyramid shape with a flat top 620 and trapezoidal shoulders 630. As mentioned above, the base of the lens 412 may be coextensive with the focal region 420.

In general, the GUI 400 has lens control elements that, in combination, provide for the interactive control of the lens 410, 610. The effective control of the characteristics of the lens 410 by a user (i.e. dynamic interaction with a detail-in-context lens) is advantageous. At any given time, one or more of these lens control elements may be made visible to the user on the display surface 340 by appearing as overlay icons on the lens 410. Interaction with each element is performed via the motion of an input or pointing device 310 (e.g. mouse), with the motion resulting in an appropriate change in the corresponding lens characteristic. As will be described, selection of which lens control element is actively controlled by the motion of the pointing device 310 at any given time is determined by the proximity of the icon representing the pointing device 310 (e.g. cursor) on the display surface 340 to the appropriate component of the lens 410. For example, “dragging” of the pointing device at the periphery of the bounding rectangle of the lens base 412 causes a corresponding change in the size of the lens 410 (i.e. “resizing”). Thus, the GUI 400 provides the user with a visual representation of which lens control element is being adjusted through the display of one or more corresponding icons.

For ease of understanding, the following discussion will be in the context of using a two-dimensional pointing device 310 that is a mouse, but it will be understood that the invention may be practiced with other 2-D or 3-D (or even greater numbers of dimensions) pointing devices including a trackball and keyboard.

A mouse 310 controls the position of a cursor icon 401 that is displayed on the display screen 340. The cursor 401 is moved by moving the mouse 310 over a flat surface, such as the top of a desk, in the desired direction of movement of the cursor 401. Thus, the two-dimensional movement of the mouse 310 on the flat surface translates into a corresponding two-dimensional movement of the cursor 401 on the display screen 340.

A mouse 310 typically has one or more finger actuated control buttons (i.e. mouse buttons). While the mouse buttons can be used for different functions such as selecting a menu option pointed at by the cursor 401, the disclosed invention may use a single mouse button to “select” a lens 410 and to trace the movement of the cursor 401 along a desired path. Specifically, to select a lens 410, the cursor 401 is first located within the extent of the lens 410. In other words, the cursor 401 is “pointed” at the lens 410. Next, the mouse button is depressed and released. That is, the mouse button is “clicked”. Selection is thus a point and click operation. To trace the movement of the cursor 401, the cursor 401 is located at the desired starting location, the mouse button is depressed to signal the computer 320 to activate a lens control element, and the mouse 310 is moved while maintaining the button depressed. After the desired path has been traced, the mouse button is released. This procedure is often referred to as “clicking” and “dragging” (i.e. a click and drag operation). It will be understood that a predetermined key on a keyboard 310 could also be used to activate a mouse click or drag. In the following, the term “clicking” will refer to the depression of a mouse button indicating a selection by the user and the term “dragging” will refer to the subsequent motion of the mouse 310 and cursor 401 without the release of the mouse button.

The GUI 400 may include the following lens control elements: move, pickup, resize base, resize focus, fold, magnify, zoom, and scoop. Each of these lens control elements has at least one lens control icon or alternate cursor icon associated with it. In general, when a lens 410 is selected by a user through a point and click operation, the following lens control icons may be displayed over the lens 410: pickup icon 450, base outline icon 412, base bounding rectangle icon 411, focal region bounding rectangle icon 421, handle icons 481, 482, 491, magnify slide bar icon 440, zoom icon 495, and scoop slide bar icon 640 (see FIG. 6). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIG. 4.

In general, when a lens 410 is selected by a point and click operation, bounding rectangle icons 411, 421 are displayed surrounding the base 412 and focal region 420 of the selected lens 410 to indicate that the lens 410 has been selected. With respect to the bounding rectangles 411, 421 one might view them as glass windows enclosing the lens base 412 and focal region 420, respectively. The bounding rectangles 411, 421 include handle icons 481, 482, 491 allowing for direct manipulation of the enclosed base 412 and focal region 420 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note that it is well within the scope of the present invention to provide a bounding region having a shape other than generally rectangular. Such a bounding region could be of any of a great number of shapes including oblong, oval, ovoid, conical, cubic, cylindrical, polyhedral, spherical, etc.

Moreover, the cursor 401 provides a visual cue indicating the nature of an available lens control element. As such, the cursor 401 will generally change in form by simply pointing to a different lens control icon 450, 412, 411, 421, 481, 482, 491, 440, 640. For example, when resizing the base 412 of a lens 410 using a corner handle 491, the cursor 401 will change form to a resize icon 490 once it is pointed at (i.e. positioned over) the corner handle 491. The cursor 401 will remain in the form of the resize icon 490 until the cursor 401 has been moved away from the corner handle 491.

Move. Lateral movement of a lens 410 is provided by the move lens control element of the GUI 400. This functionality is accomplished by the user first selecting the lens 410, 610 through a point and click operation. Then, the user points to a point within the lens 410 that is other than a point lying on a lens control icon 450, 412, 411, 421, 481, 482, 491, 440, 640. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Pickup. Lateral movement of a lens 410 is also provided by the pickup lens control element of the GUI. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs. In addition, a base outline 412 is displayed over the lens 410 representing the base 412 of the lens 410. The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the outline 412 of the lens 410 that the user repositions rather than the full lens 410.

Resize Base. Resizing of the base 412 (or outline) of a lens 410 is provided by the resize base lens control element of the GUI. After the lens 410 is selected, a bounding rectangle icon 411 is displayed surrounding the base 412. The bounding rectangle 411 includes handles 491. These handles 491 can be used to stretch the base 412 taller or shorter, wider or narrower, or proportionally larger or smaller. The corner handles 491 will keep the proportions the same while changing the size. The middle handles (not shown) will make the base 412 taller or shorter, wider or narrower. Resizing the base 412 by the corner handles 491 will keep the base 412 in proportion. Resizing the base 412 by the middle handles (not shown) will change the proportions of the base 412. That is, the middle handles (not shown) change the aspect ratio of the base 412 (i.e. the ratio between the height and the width of the bounding rectangle 411 of the base 412). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a corner handle 491 may include arrows indicating proportional resizing. The resize icon (not shown) for a middle handle (not shown) may include arrows indicating width resizing or height resizing. After pointing at the desired handle 491, the user would click and drag the handle 491 until the desired shape and size for the base 412 is reached. Once the desired shape and size are reached, the user would release the mouse button 310. The base 412 of the lens 410 is then locked in its new size and shape until a further base resize operation is performed.

Resize Focus. Resizing of the focal region 420 of a lens 410 is provided by the resize focus lens control element of the GUI. After the lens 410 is selected, a bounding rectangle icon 421 is displayed surrounding the focal region 420. The bounding rectangle 421 includes handles 481, 482. These handles 481, 482 can be used to stretch the focal region 420 taller or shorter, wider or narrower, or proportionally larger or smaller. The corner handles 481 will keep the proportions the same while changing the size. The middle handles 482 will make the focal region 420 taller or shorter, wider or narrower. Resizing the focal region 420 by the corner handles 481 will keep the focal region 420 in proportion. Resizing the focal region 420 by the middle handles 482 will change the proportions of the focal region 420. That is, the middle handles 482 change the aspect ratio of the focal region 420 (i.e. the ratio between the height and the width of the bounding rectangle 421 of the focal region 420). When a user points at a handle 481, 482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a corner handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Fold. Folding of the focal region 420 of a lens 410 is provided by the fold control element of the GUI. In general, control of the degree and direction of folding (i.e. skewing of the viewer aligned vector 231 as described by Carpendale) is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focus 420 with respect to the lens base 410. In other words, and referring to FIG. 2, the direction and degree of folding corresponds to the displacement of the point FP 233 relative to the point FPo 232, where the vector joining the points FPo 232 and FP 233 defines the viewer aligned vector 231. In particular, after the lens 410 is selected, a bounding rectangle icon 421 is displayed surrounding the focal region 420. The bounding rectangle 421 includes handles 481, 482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnify. Magnification of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (i.e. if the focal region is a plane). Again referring to FIGS. 1 and 2, magnification of the focal region 420, 233 varies inversely with the distance from the focal region 420, 233 to the reference view plane (RVP) 201. Magnification of areas lying in the shoulder region 430 of the lens 410 also varies inversely with their distance from the RVP 201. Thus, magnification of areas lying in the shoulder region 430 will range from unity at the base 412 to the level of magnification of the focal region 420.

Zoom. Zoom functionality is provided by the zoom lens control element of the GUI. Referring to FIG. 2, the zoom lens control element, for example, allows a user to quickly navigate to a region of interest 233 within a continuous view of a larger presentation 210 and then zoom in to that region of interest 233 for detailed viewing or editing. Referring to FIG. 4, the combined presentation area covered by the focal region 420 and shoulder region 430 and surrounded by the base 412 may be referred to as the “extent of the lens”. Similarly, the presentation area covered by the focal region 420 may be referred to as the “extent of the focal region”. The extent of the lens may be indicated to a user by a base bounding rectangle 411 when the lens 410 is selected. The extent of the lens may also be indicated by an arbitrarily shaped figure that bounds or is coincident with the perimeter of the base 412. Similarly, the extent of the focal region may be indicated by a second bounding rectangle 421 or arbitrarily shaped figure. The zoom lens control element allows a user to: (a) “zoom in” to the extent of the focal region such that the extent of the focal region fills the display screen 340 (i.e. “zoom to focal region extent”); (b) “zoom in” to the extent of the lens such that the extent of the lens fills the display screen 340 (i.e. “zoom to lens extent”); or, (c) “zoom in” to the area lying outside of the extent of the focal region such that the area without the focal region is magnified to the same level as the extent of the focal region (i.e. “zoom to scale”).

In particular, after the lens 410 is selected, a bounding rectangle icon 411 is displayed surrounding the base 412 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e. “zoom to focal region extent”), the user would point and click within the extent of the focal region. To zoom in to the extent of the lens such that the extent of the lens fills the display screen 340 (i.e. “zoom to lens extent”), the user would point and click within the extent of the lens. Or, to zoom in to the presentation area without the extent of the focal region, such that the area without the extent of the focal region is magnified to the same level as the extent of the focal region (i.e. “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar 650 or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the base 412 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

Scoop. The concavity or “scoop” of the shoulder region 430 of the lens 410 is provided by the scoop lens control element of the GUI. After the lens 410 is selected, the scoop control is presented to the user as a slide bar icon 640 (see FIG. 6) near or adjacent to the lens 410, 610 and typically below the lens 410. Sliding the bar 641 of the slide bar 640 results in a proportional change in the concavity or scoop of the shoulder region 430 of the lens 410. The slide bar 640 not only informs the user that the shape of the shoulder region 430 of the lens 410 may be selected, but also provides the user with an indication as to what degree of shaping is possible. The slide bar 640 includes a bar 641 that may be slid left and right, or up and down, to adjust and indicate the degree of scooping. To control the degree of scooping, the user would click on the bar 641 of the slide bar 640 and drag in the direction of desired scooping degree. Once the desired degree of scooping is reached, the user would release the mouse button 310. The lens 410 is then locked with the selected scoop until a further scooping operation is performed.

Icon Hiding. Advantageously, a user may choose to hide one or more lens control icons 450, 412, 411, 421, 481, 482, 491, 440, 495, 640 shown in FIGS. 4 and 6 from view so as not to impede the user's view of the image within the lens 410. This may be helpful, for example, during an editing or move operation. A user may select this option through means such as a menu, toolbar 650, or lens property dialog box.

Redo and Undo. In addition, the GUI 400 maintains a record of control element operations such that the user may restore pre-operation presentations. This record of operations may be accessed by or presented to the user through “Undo” and “Redo” icons 497, 498, through a pull-down operation history menu (not shown), or through a toolbar 650.

Presenting and Editing Multi-Layer Images with Detail-In-Context Lenses. One of the most common, yet troublesome, tasks in editing digital images is to precisely mark areas of interest. Using detail-in-context technology such as PDT, an area of interest can be magnified to pixel level resolution and then modified with pixel accuracy. Detail-in-context data viewing techniques allow a user to view multiple levels of detail or resolution on one display 340. The appearance of the data display or presentation is that of one or more virtual lens showing detail 233 within the context of a larger area view 210. Using multiple lenses in detail-in-context data presentations may be used to compare two regions of interest at the same time. Folding enhances this comparison by allowing the user to pull the regions of interest closer together. In accordance with the present invention, detail-in-context lenses may be used to present and edit multi-layer digital images. The editing may include a hi-lighting, mark-up, cut & paste, crop, and drag & drop operations. For example, using a detail-in-context technology such as PDT, a user can enlarge an area of interest to more clearly view an area to be marked for subsequent editing. The user may then have the option of saving the edited image or cancelling the operation.

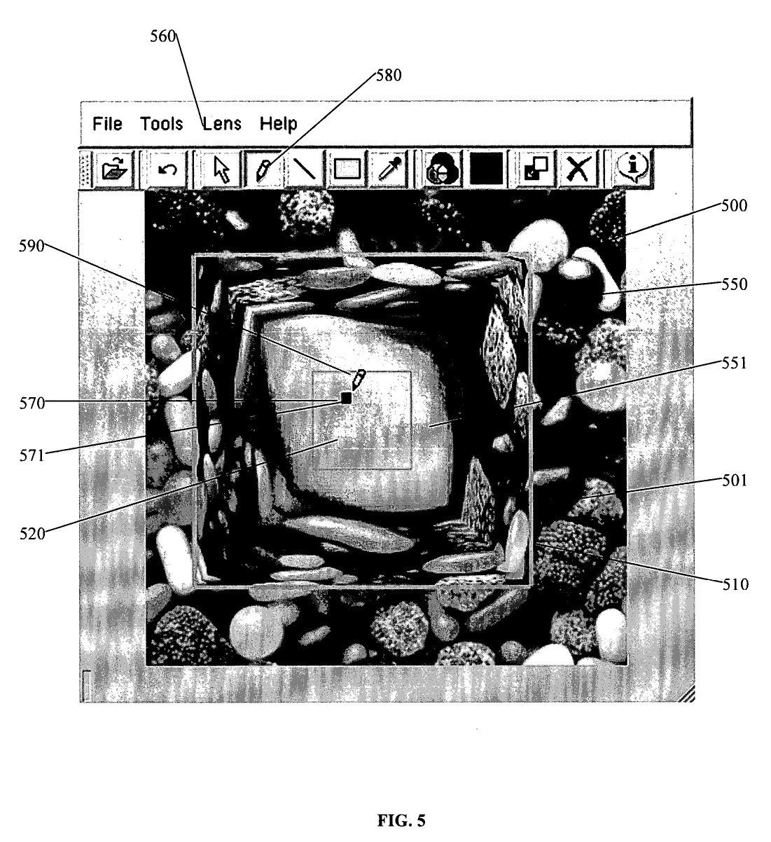

FIG. 5 is a screen capture illustrating a presentation 500 having a detail-in-context lens 510 and an associated GUI 501 for editing an original single-layer digital image or representation in accordance with an embodiment of the invention. In FIG. 5, the original single-layer image to be edited is that of a number of candies 550. In order to produce an edited image of a selected candy 551, for example, a user defines a lens 510 over the candy 551 using the GUI 501. The lens 510 may be introduced to the original image to form the illustrated presentation 500 through the use of a pull-down menu selection, tool bar icon 560, etc. Using lens control elements for the GUI 501, such as move, pickup, resize base, resize focus, fold, magnify, zoom, and scoop, as described above, the user adjusts the lens 510 to accurately select a point 570 or area on the candy 551 for editing. Each selected point 570 or area may be indicated in the presentation 500 with a box icon 571, for example. Using the magnify lens control element, for example, the user may magnify the focal region 520 of the lens 510 to pixel quality resolution making it easy to view, for example, the region about the selected point 570 or area.

Once the lens 510 is in place, the user may use an existing tool 580 to edit the original image through the presentation 500 to produce an edited image. Advantageously, because the selected point 570 is contained within the focal region 520 of the lens 510 which may be displayed at a higher resolution that the surrounding presentation 500, the editing operation may be performed more accurately. In FIG. 5, the digital image has one layer and so edits affect only that layer image.

Now, consider the editing of multi-layer images. The present invention may be applied in a number of applications. For example, map servers create maps based on requested layers, location, and resolution. Such applications are conducive to “scale-dependent rendering”. That is, a base image (i.e., the image outside the extent of the lens) is displayed at a low resolution while a lens image (i.e., the image within the extent of the lens) is displayed at a resolution based on a user selected magnification 440, 441. Such applications are also conducive to geo-referencing data. Moreover, the base and lens images may represent different layers of the original multilayer image. Or, they may be different but related images. Of course layered images do not necessarily have to be associated with scale-dependent rendering. For example, consider a number of images that line up spatially. These images may include aerial photos of a particular location taken at various times of the day. Or, consider a number of drawings relating to the design of a building: an outside elevation drawing, a corresponding internal structural drawing, and a corresponding internal electrical wiring drawing. The present invention may also be applied in CAD and photographic imaging software packages that provide image layering capabilities. Moreover, the present invention may be applied in medical imaging and spectral imaging applications where layering is used to identify changes in data over time. The present invention does not require that multiple layer be exactly aligned or highly related. Finally, the invention can also be applied in cases where one layer has a clear image but it is desired to find a given area in a second layer. As will be described below, penetration of edits makes this task easier. For example, a user who cannot find a house in an aerial image layer of a city neighbourhood may mark the house in a street map layer then switch back to the aerial view layer to locate the house.

FIG. 6 is a screen capture illustrating a presentation 600 having a detail-in-context lens 610 and an associated GUI 601 for editing an original multi-layer digital image or representation in accordance with an embodiment of the invention. In FIG. 6, the base image 670 (i.e., that portion of presentation 600 outside the extent of the lens 610) is a street map of South Seattle. The lens image 680 (i.e., that portion of the presentation 600 within the extent of the lens 610 and including the focal 620 and shoulder 630 regions of the lens 610) is an aerial photograph of the corresponding area of South Seattle. The base image 670 and lens image 680 are spatially aligned and represent portions of the first and second layers of the original multi-layer digital image. Thus, the presentation 600 allows a user to view portions 670, 680 of two layers of the original multi-layer image simultaneously and in-context. Note the wharf area 681 shown within the focal region 620 of the lens 610.

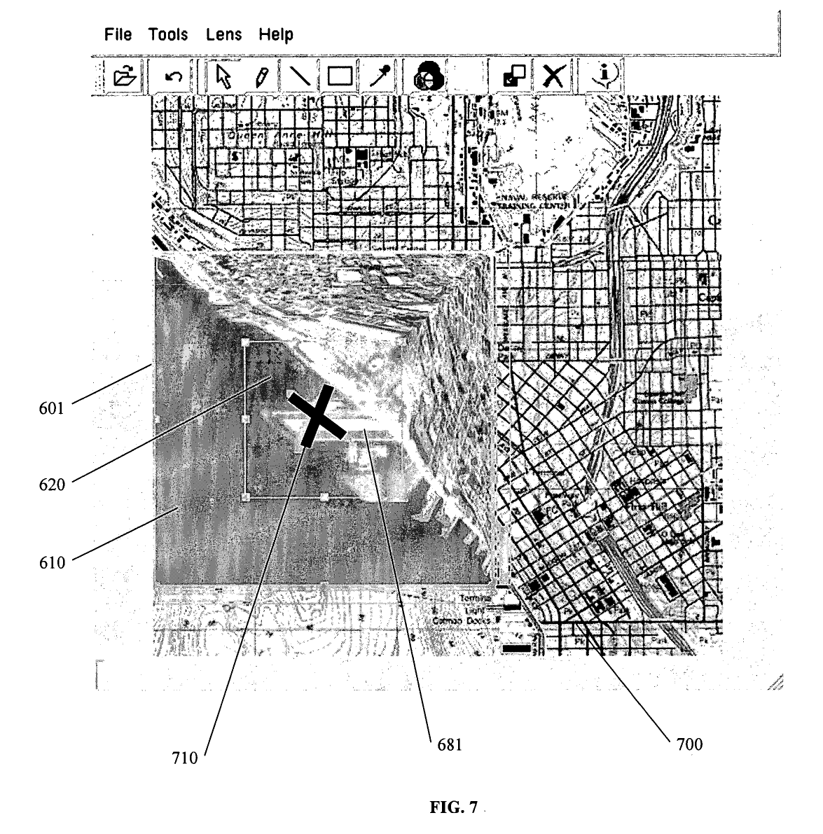

FIG. 7 is a screen capture illustrating the placement of a mark 710 over a selected area or object 681 (e.g., a wharf) in the lens image 680 for a layer of an original multi-layer digital image or representation in accordance with an embodiment of the invention. According to an embodiment of the present invention, a user can place a mark (or icon, symbol, etc.) 710, for subsequent editing operations, on a selected area or point 681 in the lens image 680 for one or more visible layers of the original image included in the lens image 680 and that mark 710 will penetrate through to the other layers of the original image. In FIG. 7, the mark 710 is placed over the wharf area 681 in the approximate centre of the focal region 620 of the lens 610. The original image layer corresponding to the lens image 680 has thus been modified or edited by adding an “X” mark 710 over the wharf 681 in the presentation 700. That is, the placement of the mark 710 represents an editing operation and the penetration of the mark 710 through to the other layers of the original image represents a multi-layer editing operation.

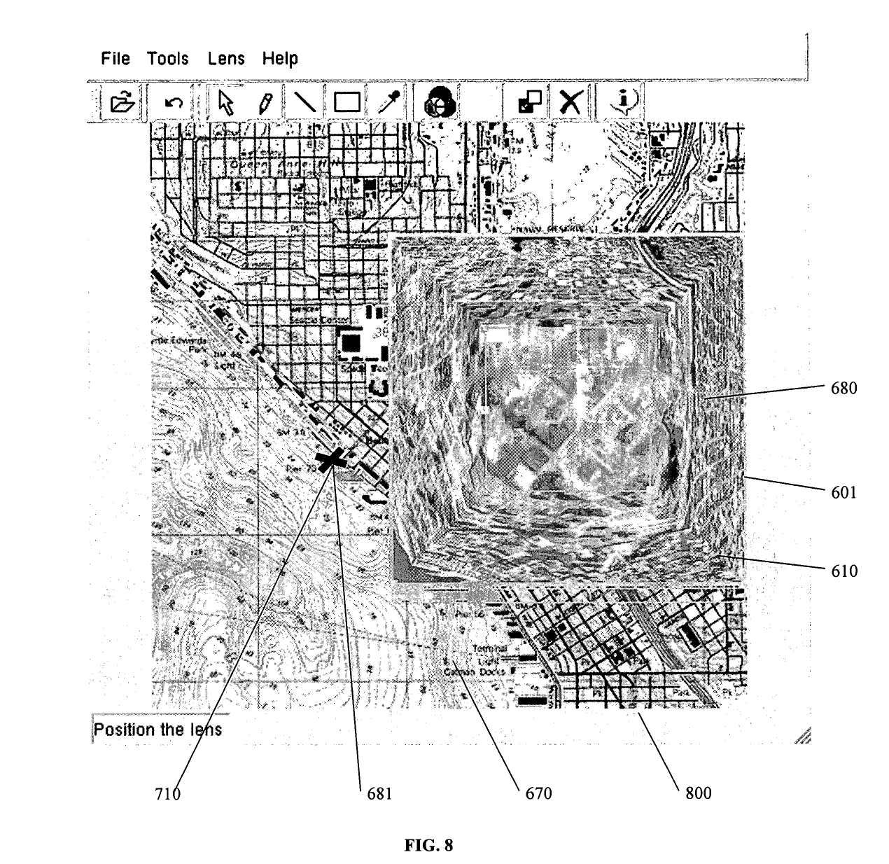

FIG. 8 is a screen capture illustrating the penetration of a mark 710 placed over a selected area or object 681 (e.g., a wharf) in a first layer of an original multi-layer digital image or representation through to a second layer of that original image in accordance with an embodiment of the invention. In FIG. 8, the lens 610 has been moving to the right and away from the wharf area 681. Note that the street map layer of the original image also has an “X” mark 710 over it in a location corresponding to the “X” mark 710 that was placed in the aerial photograph layer of the original image in FIG. 7. In FIG. 8, the mark 710 is now presented within the base image 670 of the presentation 800 as the lens image 680 has been shifted to the right. The editing operation may be also penetrate to any additional layers of the original image such as a utility map. Edited layers may be selectively saved by the user for subsequent access.

In operation, the data processing system 300 employs EPS techniques with an input device 310 and GUI 601 for selecting areas 681 or objects on which to perform an editing operation for display to a user on a display screen 340. Data representing an original image or representation is received by the CPU 320 of the data processing system 300. Using EPS techniques, the CPU 320 processes the data in accordance with instructions received from the user via an input device 310 and GUI 601 to produce a detail-in-context presentation 600. The presentation 600 is presented to the user on a display screen 340. It will be understood that the CPU 320 may apply a transformation to the shoulder region 630 surrounding the region-of-interest 620 to affect blending or folding in accordance with EPS technology. For example, the transformation may map the region-of-interest 620 and/or shoulder region 630 to a predefined lens surface, defined by a transformation or distortion function and having a variety of shapes, using EPS techniques. Or, the lens 610 may be simply coextensive with the region-of-interest 620. (Blending and folding of lenses in detail-in-context presentations are described in U.S. patent application Publication No. 2002/0044154 which is incorporated herein by reference.)

The lens control elements of the GUI 601 are adjusted by the user via an input device 310 to control the characteristics of the lens 610 in the detail-in-context presentation 600, 700, 800. Using an input device 310 such as a mouse, a user adjusts parameters of the lens 610 using icons and scroll bars of the GUI 601 that are displayed over the lens 610 on the display screen 340. The user may also adjust parameters of the image of the full scene. Signals representing input device 310 movements and selections are transmitted to the CPU 320 of the data processing system 300 where they are translated into instructions for lens control.

In addition, when the editing tool 580 is activated (e.g. by a drop-down menu selection, tool bar, etc.) and when the standard cursor 401 is located within the presentation 600, an alternate cursor icon 590 may be displayed over the presentation 500 to replace the cursor 401 or may be displayed in combination with the cursor 401.

Moreover, the lens 610 may be added to the presentation 600 before or after the area 681 or object is selected. That is, the user may first add a lens 610 to a presentation 600 or the user may move a pre-existing lens into place over the selected area 681 or object. The lens 610 may be introduced to the original image to form the presentation 600 through the use of a pull-down menu selection, tool bar icon, etc. The editing operation may then be activated using a toolbar selection 580 or with a double click on the selected area 681 or object.

Advantageously, by using a detail-in-context lens 610 to select an area or point 710 for an editing operation, a user can view a large area 670 (i.e., outside the extent of the lens 610) while focusing in on a smaller area 680 (or within the focal region 620 of the lens 610) surrounding the selected point 710. This makes it possible for a user to perform an accurate editing operation without losing visibility or context of the portion of the original image surrounding the selected point 710.

According to an embodiment of the present invention, the GUI 601 may include the following additional control elements that are applicable to multi-layer detail-in-context presentations: layer toggle, layer selection, layer fold, and layer clear. In addition, associated layer toggle, layer selection, layer fold, and layer clear icons (not shown) may be displayed over the lens 410 or on a toolbar 650 or pull-down menu. Moreover, when layer toggle, layer selection, layer fold, and layer clear functionality is selected by the user, for example, through a toolbar 650 or pull-down menu, corresponding alternate cursor icons (not shown) may be displayed to replace the cursor 401 or may be displayed in combination with the cursor 401. The layer toggle, layer selection, layer fold, and layer clear control elements are described below.

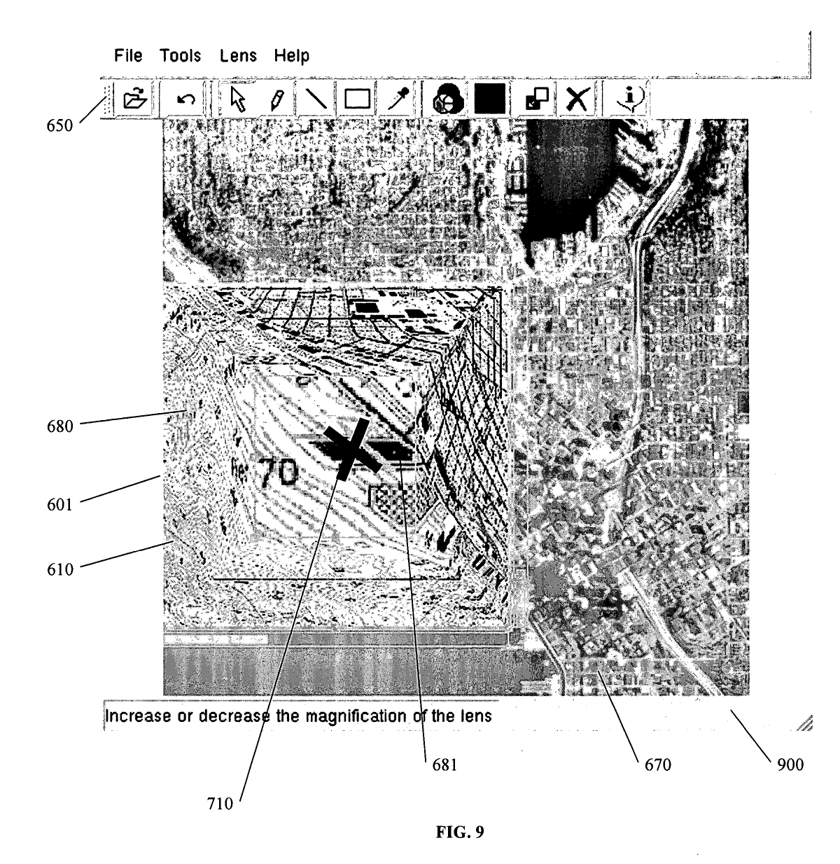

FIG. 9 is a screen capture illustrating the effect of a layer toggle control element on a detail-in-context presentation 900 for a multi-layer original image in accordance with an embodiment of the invention. The layer toggle control element may have an associated toggle button icon (not shown) for initiating a toggle operation through a point and click operation. When activated, the layer toggle control element causes the layers presented in the base and lens images 670, 680 of the presentation 900 to be switched. Thus, in FIG. 9, a portion of the aerial photograph layer is presented in the base image 670 while a portion of the street map layer is presented in the lens image 680. The layer toggle control element simplifies the process of checking whether an edit 710 made to one layer has indeed penetrated through to the next layer. If the original image includes more than two layers, or if more than two layers are included in the presentation 900, then subsequent selections of the toggle button icon will move a new layer into the lens image 680 in sequence. Comparing FIGS. 8 and 9, it is apparent that the use of the toggle button to switch layers simplifies the process of checking whether the ‘X’ mark 710 has indeed modified both layers of the original image. With the toggle button, the user need not move the lens 610 away from the mark 710 to perform this check.

The layer selection control element may have an associated layer selection button icon or icons (not shown) or pull-down menu (not shown) for initiating a layer selection operation through a point and click operation or by using a keyboard (e.g., each number or function key could add a layer, etc.). When activated, the layer selection control element causes selected additional layers of the original multi-layer image to be added to the presentation 600. To ease user selection, individual layer selection icons for each available layer may be distributed along the bounding rectangle icons 411, 421 or over the handle icons 481, 482, 491 of the GUI 400, 601.

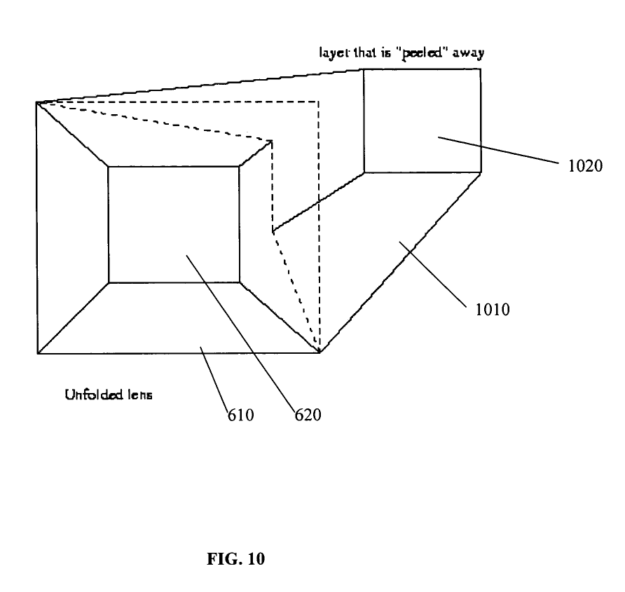

FIG. 10 is a schematic diagram illustrating the folding of the focal region 620 of a lens 610 to produce a folded lens 1010 having a folded focal region 1020 in accordance with an embodiment of the invention. Now, as described by Carpendale and referring again to FIG. 2, EPS technology includes a technique referred to as “folding” in which an in-context detail view of information can be displaced so as to move the region-of-interest 233 within the plane 201 of the display while maintaining a continuous connection with at least some of the contextual information 210. In other words, the region-of-interest is folded over a portion of the visual information comprising the area surrounding the region-of-interest. According to one embodiment of the present invention, a novel form of folding is applied to a multi-layer original image to create a presentation 1100 in which a user may view a detailed portion of an underlying layer.

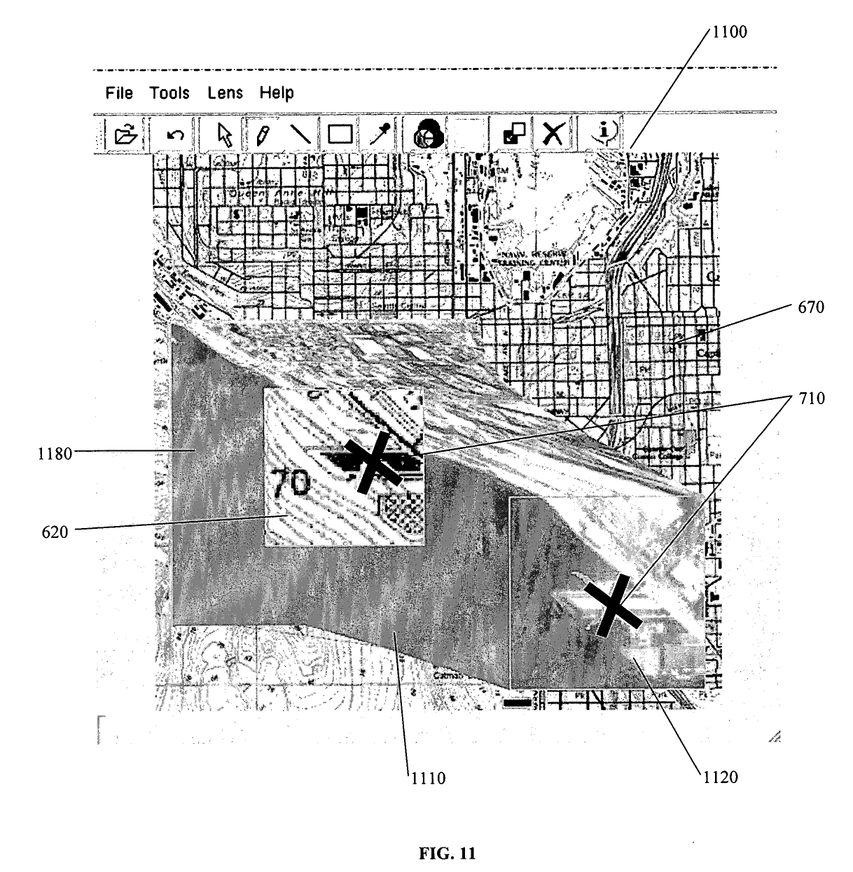

FIG. 11 is a screen capture illustrating the effect of a layer fold control element on a detail-in-context presentation 1100 for a multi-layer original image in accordance with an embodiment of the invention. The layer fold control element may have an associated fold button icon (not shown) for initiating a fold operation through a point and click operation. When activated, the layer fold control element causes the focal region 620 of a lens 610 in a lens image 680 to be folded over a portion of the surrounding base image 670 to produce a folded lens image 1180 having a folded lens 1110 with a folded focal region 1120 for a first layer of the original multi-layer image and retaining the unfolded focal region 620 from the unfolded lens 610. This unfolded focal region 620 presents a “lensed” portion of a second layer of the original multi-layer image. This second layer is also presented in the base image 670 surrounding the folded lens image 1180. Thus, when the layer fold control element is applied, the effect is that of leaving the focal region 620 of the lens 610 behind to reveal the base layer while the detail in the folded focal region 1120 reveals the lens layer that was originally in the lens 610. In this way one layer can be “peeled” away so that two layers can be viewed at the same time. In other words, folding is applied to the lens for an upper layer to reveal the focus of a lens applied to the layer below.

Advantageously, and comparing FIGS. 8 and 11, it is apparent that the use of fold button simplifies the process of checking whether the ‘X’ mark 710 has indeed modified both layers of the original image. With the fold button, the user need not move the lens 610 away from the mark 710 to perform this check nor switch layers within the lens image 1180.

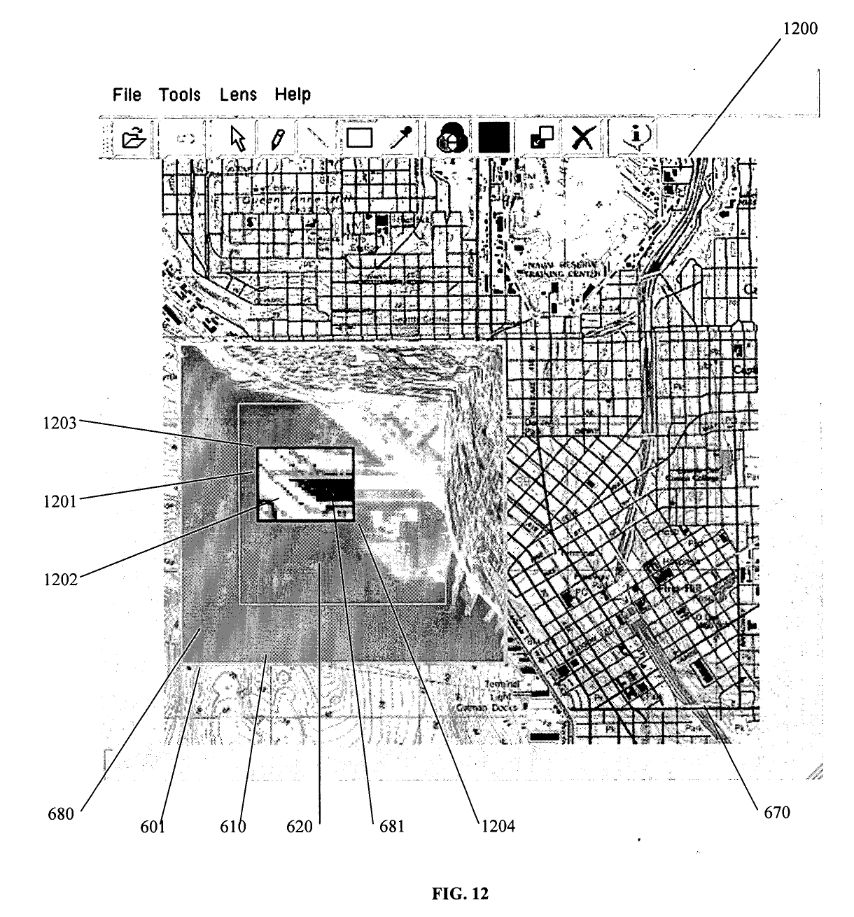

FIG. 12 is a screen capture illustrating the effect of a layer clear control element on a detail-in-context presentation 1200 for a multi-layer original image in accordance with an embodiment of the invention. The layer clear control element may have an associated layer clear button icon (not shown) for initiating a layer clear operation through a point and click operation. When activated, the layer clear control element causes a layer clear bounding rectangle icon 1201 to be displayed within the focal region 620 of the lens image 680 for a first layer of the original multi-layer image. The window 1202 defined by the bounding rectangle 1201 presents a “lensed” portion of a second layer of the original multi-layer image. This second layer is also presented in the base image 670 surrounding the lens image 680.

The bounding rectangle icon 1201 indicates the selected area for the window 1202. The bounding rectangle icon 1201 may be presented automatically upon selection of the layer clear button. The size and shape of this default bounding rectangle 1201 may then be adjusted by the user. Or, the upon selection of the layer clear button, the user may be allowed to draw the bounding rectangle 1201 from scratch. For example, the bounding rectangle icon 1201 may be drawn by first activating the layer clear control element (e.g., by a button or tool bar selection, etc.), followed by a point and click operation to locate the first corner 1203 with a cursor 401 and mouse 310, while maintaining a depressed mouse selection button, a drag operation, and then a mouse selection button release to select the second corner 1204. During this process, the bounding rectangle icon 1201 and the window 1202 it defines may be dynamically presented as the cursor 401 is moved by the user. Of course the bounding rectangle icon 1201 and window 1202 may have a shape other than rectangular.

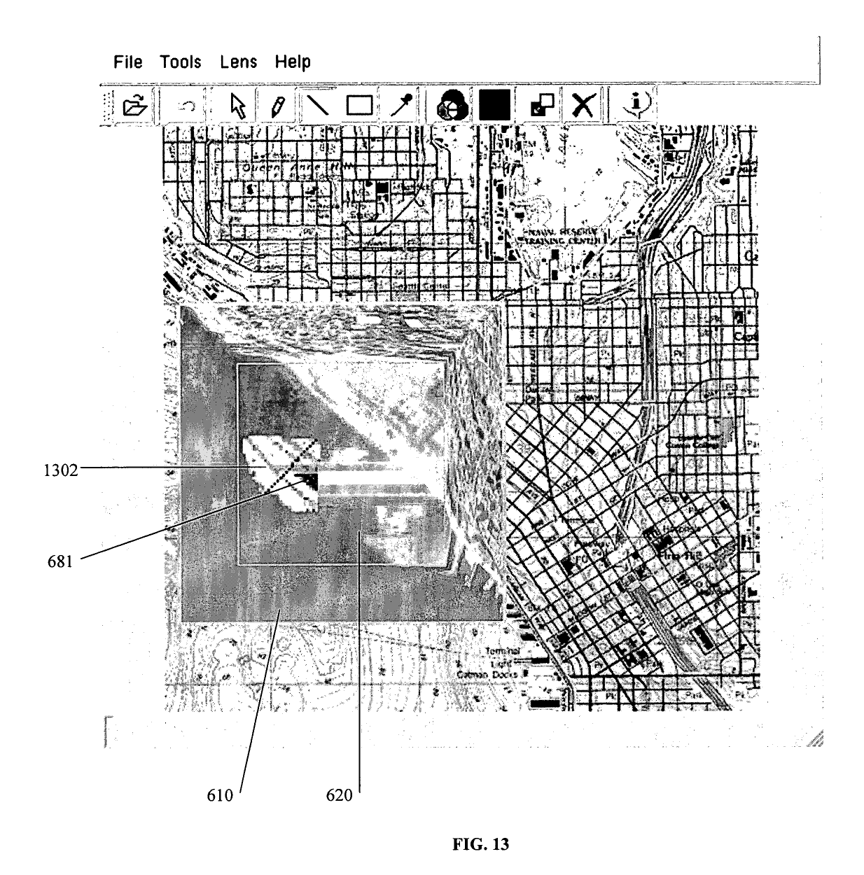

Thus, the layer clear control element provides another method to view the base layer through the lens 610 by effectively opening a window 1202 in the occluding upper layer presented by the lens image 680. The layer clear functionality allows a user to define a bounding rectangle 1201 or other shape over the area 1202 of the lens image 680 that the user wishes to clear or render transparent. The layer clear control element is interactive in that as the bounding rectangle 1201 and window 1202 increases in size, more of the occluding layer (i.e., the upper layer) is cleared. The bounding rectangle icon 1201 and window 1202 act like a windshield wiper to clear the occluding layer. The layer clear control element may be applied to layers of the original multi-layer image that are rendered in the lens based on the magnification of the lens (i.e. scale-dependent rendering). FIG. 13 is a screen capture illustrating a non-rectangular layer clear window 1302 in which the occluded layer presented is further magnified, in accordance with an embodiment of the invention.

According to another embodiment of the invention, a user may edit a first layer through the base image 670 and this edit may penetrate through to a second layer presented in the lens image 680.

According to another embodiment of the invention, all layers of the original image can be modified if an editing operation is performed on one layer.

According to another embodiment of the invention, only user selected layers are modified when an editing operation is performed on one layer.

According to anther embodiment of the invention, layers may be edited without presenting a lens image 680.

According to another embodiment of the invention, edited areas 681 may be bookmarked and the bookmarks may be saved and accessed through a list of bookmarks in a pull-down menu for subsequent recall and application. Bookmarks may also be saved as files and emailed to others who already have the original image and may just want to see the edits or edited areas. Bookmarks may be used for subsequent recall on future images, for example and referring to FIG. 6, future images of South Seattle. Bookmarks provide a means for saving the edits without having to save the whole image. Bookmarks, or saved edits, may also be geo-referenced and used with geo-referenced images. For example, map servers typically do not allow edits, but if edits are saved in a geo-referenced manner, then they may be overlaid on images requested from a map server.

According to another embodiment of the invention, a lens 610 may be moved along a predetermined path in a layer of the original image, for example along a street in a street map layer 670, to allow a user to inspect and edit the entire path. This is advantageous as the user may accurately select all points along the path rather that just end points. In so doing, a more accurate edited image may be produced.

According to another embodiment of the invention, multiple lenses 610 may be included in a presentation 600. Each lens image 680 may show a portion of a different layer of the original multi-layer image. For example, the base image 670 may show a street map layer, a first lens image 680 may show a daytime aerial photograph layer, and a second lens image (not shown) may show a night-time aerial photograph image. Moreover, blending within a lens image 680 may be used to generate an afternoon aerial photograph image. Any of the multiple lenses 610 may be used for editing.

According to another embodiment of the invention, the area outside of the extent of the lens 610, the shoulder region 630 of the lens 610, and the focal region 620 of the lens 610 may each be used to view a different layer of the original multi-layer image. Similarly, the lens 610 may be configured with as manner shoulder regions 630 as necessary to view all of the available layers of an original image. For example, an original image having five layers may be viewed with a five step pyramid lens (i.e., the region outside of the extent of the lens 610, three concentric shoulder regions 630, and one focal region 620).

According to another embodiment of the invention, each layer of the original multi-layer image may include data of a different type. For example, layers may include a raster data, a vector data, and a point data layers.

According to another embodiment of the invention, the presentation 600 may include multiple windows (not shown) for concurrent viewing of selected layers of the original multi-layer image. For example, a first window may show a raster data layer while a second window may show a vector data layer. In addition, each window may have its own lens 610. Editing a layer through the lens 610 displayed in the first window will also modify the layer shown in the second window.

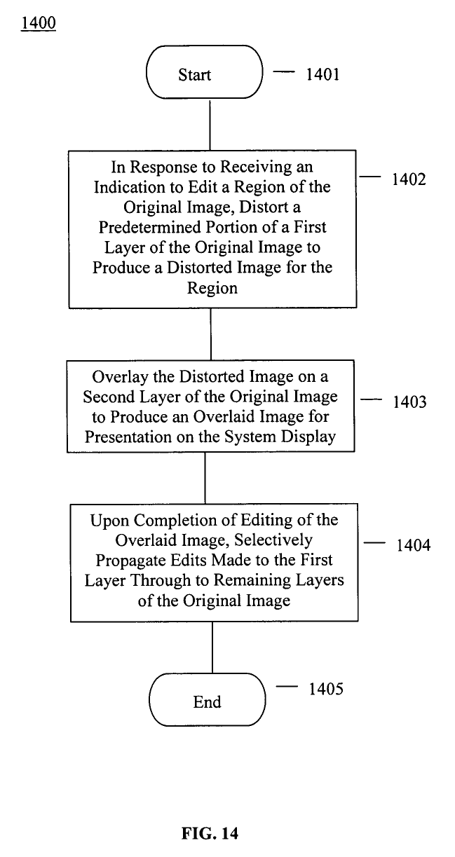

Method. FIG. 14 is a flow chart 1400 illustrating a method for editing a multi-layer original image presented on a system display 340 in accordance with an embodiment of the invention. At step 1401, the method starts.

At step 1402, in response to receiving an indication to edit a region 681 of the original image, a predetermined portion of a first layer of the original image is distorted to produce a distorted image 680 for the region 681. Preferably, this step of distorting further includes: creating a lens surface 610 for the distorted image 680; and, transforming the predetermined portion of the first layer by applying a distortion function defining the lens surface 610 to the predetermined portion of the first layer. Preferably, this step of creating further includes displaying a GUI 601 over the distorted image 680 for adjusting the lens surface 610. Preferably, the lens surface 610 includes a focal region 620 and a base region 412 and the GUI 601 includes: a slide bar icon 440 for adjusting a magnification for the lens surface 610; a slide bar icon 640 for adjusting a degree of scooping for the lens surface 610; a bounding rectangle icon 421 with at least one handle icon 481 for adjusting a size and a shape for the focal region 620; a bounding rectangle icon 411 with at least one handle icon 491 for adjusting a size and a shape for the base region 412; a move icon 460 for adjusting a location for the lens surface 610 within the first layer; a pickup icon 450 for adjusting a location for the base region 412 within the first layer; and, a fold icon 470 for adjusting a location for the focal region 620 relative to the base region 412.

Preferably, the GUI 601 further includes a layer toggle icon for switching the first and second layers. Preferably, the GUI 601 further includes a layer selection icon for selecting the first and second layers. Preferably, the GUI 601 further includes a layer fold icon for selecting a folded lens surface 1110. Preferably, the folded lens surface 1110 includes a second focal region 620 for displaying a portion of the second layer. Preferably, the focal region 1120 is folded away from an original position 620 relative to the base region 412. Preferably, the second focal region 620 is located at the original position 620. Preferably, the GUI 601 further includes a layer clear icon for selecting a user adjustable window 1202 for display in the focal region 620. Preferably, the window 1202 displays a portion of the second layer.

At step 1403, the distorted image 680 is overlaid on a second layer of the original image to produce an overlaid image 600 for presentation on the system display 340. Preferably, the first and second layers are one or more of raster, vector, and point data layers. Preferably, the second layer is a plurality of second layers.

At step 1404, upon completion of editing of the overlaid image 600, edits 710 made to the first layer are selectively propagated through to remaining layers of the original image. Preferably, adjusting the GUI 601 is performed and the editing indication is generated by moving a cursor 401 on the system display 340 with a pointing device 310.

At step 1405, the method ends.

Data Carrier Product. The sequences of instructions which when executed cause the method described herein to be performed by the exemplary data processing system of FIG. 3 can be contained in a data carrier product according to one embodiment of the invention. This data carrier product can be loaded into and run by the exemplary data processing system of FIG. 3.

Computer Software Product. The sequences of instructions which when executed cause the method described herein to be performed by the exemplary data processing system of FIG. 3 can be contained in a computer software product according to one embodiment of the invention. This computer software product can be loaded into and run by the exemplary data processing system of FIG. 3.

Integrated Circuit Product. The sequences of instructions which when executed cause the method described herein to be performed by the exemplary data processing system of FIG. 3 can be contained in an integrated circuit product including a coprocessor or memory according to one embodiment of the invention. This integrated circuit product can be installed in the exemplary data processing system of FIG. 3.

Although preferred embodiments of the invention have been described herein, it will be understood by those skilled in the art that variations may be made thereto without departing from the spirit of the invention or the scope of the appended claims.

The embodiment of the invention in which an exclusive property or privilege is claimed are defined as follows:

1. A method for editing a multi-layer original image presented on a system display, comprising:
in response to receiving an indication to edit a region of said original image, distorting a predetermined portion of a first layer of said original image to produce a distorted image for said region;
overlaying said distorted image on a second layer of said original image to produce an overlaid image for presentation on said system display; and,
upon completion of editing of said overlaid image, selectively propagating edits made to said first layer through to remaining layers of said original image.

2. The method of claim 1 wherein said distorting further includes:
creating a lens surface for said distorted image; and,
transforming said predetermined portion of said first layer by applying a distortion function defining said lens surface to said predetermined portion of said first layer.

3. The method of claim 2 wherein said creating further includes displaying a graphical user interface (“GUI”) over said distorted image for adjusting said lens surface.

4. The method of claim 3 wherein said lens surface includes a focal region and a base region and said GUI includes: a slide bar icon for adjusting a magnification for said lens surface; a slide bar icon for adjusting a degree of scooping for said lens surface; a bounding rectangle icon with at least one handle icon for adjusting a size and a shape for said focal region; a bounding rectangle icon with at least one handle icon for adjusting a size and a shape for said base region; a move icon for adjusting a location for said lens surface within said first layer; a pickup icon for adjusting a location for said base region within said first layer; and, a fold icon for adjusting a location for said focal region relative to said base region.

5. The method of claim 4 wherein said GUI further includes at least one of a layer toggle icon and a layer toggle keyboard input for switching among said first and second layers.

6. The method of claim 5 wherein said GUI further includes at least one of a layer selection icon and a layer selection keyboard input for selecting among said first and second layers.

7. The method of claim 6 wherein said GUI further includes at least one of a layer fold icon and a layer fold keyboard input for selecting a folded lens surface.

8. The method of claim 7 wherein said folded lens surface includes a second focal region for displaying a portion of said second layer.

9. The method of claim 8 wherein said focal region is folded away from an original position relative to said base region.

10. The method of claim 9 wherein said second focal region is located at said original position.

11. The method of claim 10 wherein said GUI further includes at least one of a layer clear icon and a layer clear keyboard input for selecting a user adjustable window for display in said focal region.

12. The method of claim 11 wherein said window displays a portion of said second layer.

13. The method of claim 4 wherein said adjusting is performed and said indication is generated by moving a cursor on said system display with a pointing device.

14. The method of claim 1 wherein said first and second layers are one or more of raster, vector, point, and geo-referenced data layers.

15. The method of claim 1 wherein said indication, region, predetermined portion, first layer, distorted image, and second layer includes a plurality of indications, regions, predetermined portions, first layers, distorted images, and second layers, respectively.

16. The method of claim 11 wherein said layer toggle icon, layer toggle keyboard input, layer selection icon, layer selection keyboard input, layer fold icon, layer fold keyboard input, layer clear icon, and layer clear keyboard input includes a plurality of layer toggle icons, layer toggle keyboard inputs, layer selection icons, layer selection keyboard inputs, layer fold icons, layer fold keyboard inputs, layer clear icons, and layer clear keyboard inputs, respectively.

17. The method of claim 1 and further comprising saving said edits for subsequent recall and application.

18. The method of claim 17 wherein said edits are saved as bookmarks.

19. The method of claim 18 wherein said editing includes applying said bookmarks.

20. A method for presenting a region of a multi-layer original image on a system display, comprising:
distorting a predetermined portion of a first layer of said original image to produce a distorted image for said region; and,
overlaying said distorted image on a second layer of said original image for presentation on said system display.

21. The method of claim 20 wherein said distorting further includes:
creating a lens surface for said distorted image; and,
transforming said predetermined portion of said first layer by applying a distortion function defining said lens surface to said predetermined portion of said first layer.

22. The method of claim 21 wherein said creating further includes displaying a graphical user interface (“GUI”) over said distorted image for adjusting said lens surface.

23. The method of claim 22 wherein said lens surface includes a focal region and a base region and said GUI includes: a slide bar icon for adjusting a magnification for said lens surface; a slide bar icon for adjusting a degree of scooping for said lens surface; a bounding rectangle icon with at least one handle icon for adjusting a size and a shape for said focal region; a bounding rectangle icon with at least one handle icon for adjusting a size and a shape for said base region; a move icon for adjusting a location for said lens surface within said first layer; a pickup icon for adjusting a location for said base region within said first layer; and, a fold icon for adjusting a location for said focal region relative to said base region.

24. The method of claim 23 wherein said GUI further includes at least one of a layer toggle icon and a layer toggle keyboard input for switching among said first and second layers.

25. The method of claim 24 wherein said GUI further includes at least one of a layer selection icon and a layer selection keyboard input for selecting among said first and second layers.

26. The method of claim 25 wherein said GUI further includes at least one of a layer fold icon and a layer fold keyboard input for selecting a folded lens surface.

27. The method of claim 26 wherein said folded lens surface includes a second focal region for displaying a portion of said second layer.

28. The method of claim 27 wherein said focal region is folded away from an original position relative to said base region.

29. The method of claim 28 wherein said second focal region is located at said original position.

30. The method of claim 29 wherein said GUI further includes at least one of a layer clear icon and a layer clear keyboard input for selecting a user adjustable window for display in said focal region.

31. The method of claim 30 wherein said window displays a portion of said second layer.

32. The method of claim 23 wherein said adjusting is performed by moving a cursor on said system display with a pointing device.

33. The method of claim 20 wherein said first and second layers are one or more of raster, vector, point, and geo-referenced data layers.

34. The method of claim 20 wherein said indication, region, predetermined portion, first layer, distorted image, and second layer includes a plurality of indications, regions, predetermined portions, first layers, distorted images, and second layers, respectively.

35. The method of claim 30 wherein said layer toggle icon, layer toggle keyboard input, layer selection icon, layer selection keyboard input, layer fold icon, layer fold keyboard input, layer clear icon, and layer clear keyboard input includes a plurality of layer toggle icons, layer toggle keyboard inputs, layer selection icons, layer selection keyboard inputs, layer fold icons, layer fold keyboard inputs, layer clear icons, and layer clear keyboard inputs, respectively.
